(19) United States
(12) Patent Application Publication
(10) Pub. No.: US 2014/0306862 A1
(43) Pub. Date: Oct. 16, 2014

(54) DISPLAY SYSTEM AND METHOD FOR DISPLAYING INFORMATION

(71) Applicant: Gulfstream Aerospace Corporation, Savannah, GA (US)

(72) Inventor: Frank Manochio, Savannah, GA (US)

(73) Assignee: Gulfstream Aerospace Corporation, Savannah, GA (US)

(21) Appl. No.: 14/243,674

(22) Filed: Apr. 2, 2014

Related U.S. Application Data
(60) Provisional application No. 61/812,008, filed on Apr. 15, 2013.

(51) Int. Cl. B64D 43/00; G09G 3/00

(52) U.S. Cl. CPC B64D 43/00; G09G 3/002
USPC 345/1.3

(57) ABSTRACT

A display system is disclosed herein. The display system includes, but is not limited to, a rear projection screen. The display system further includes, but is not limited to, a first projector arranged to project a first image on the rear projection screen. The display system further includes a second projector arranged to project a second image on the rear projection screen. The display system still further includes a processor that is operatively coupled with the first projector and the second projector. The processor is configured to control the first projector to project the first image and to control the second projector to project the second image, and is further configured to align the second image with the first image in an overlaying manner so as to create the appearance of a single image, a portion of the second image being substantially identical to a portion of the first image.

### CROSS-REFERENCE TO RELATED APPLICATION

This application claims the benefit of co-pending U.S. Provisional Patent Application 61/812,008 filed 15 Apr., 2013 and entitled “Rear Projection Flight Display”, which is hereby incorporated herein by reference in its entirety.

### TECHNICAL FIELD

The present invention relates to display systems and methods for displaying information.

### BACKGROUND

Throughout the course of aviation history, the number and complexity of systems onboard an aircraft that are needed to control the aircraft and ensure flight safety has grown substantially. As the number and complexity of onboard systems has grown, the amount of information that a pilot needs to access during aircraft operations has also grown. Accordingly, the modern flight deck is equipped with a display system that includes multiple video monitors arranged side by side, housed in an instrument panel that extends from wall to wall. Each video monitor presents specific and predetermined information with little or no repetition.

While the above described display system is adequate, there is room for improvement. Specifically, display systems used in today's flight decks do not offer as much redundancy as is desirable. For example, in the event that one or more of the video monitors described above fails during operation of the aircraft, the flight crew may not be able to complete its mission. This is because the malfunctioning monitor(s) displays a substantial portion of the total amount of information that a pilot needs to operate the aircraft. Without that information, the flight crew may not be able to carry on.

Accordingly, it is desirable to provide a display system that provides greater levels of redundancy than are currently available in conventional display systems. In addition, it is desirable to provide a method for displaying information in a manner that provides the desired levels of redundancy. Furthermore, other desirable features and characteristics will become apparent from the subsequent summary and detailed description and the appended claims, taken in conjunction with the accompanying drawings and the foregoing technical field and background.

### BRIEF SUMMARY

A display system and a method of displaying information is disclosed herein.

In a first non-limiting embodiment, the display system includes, but is not limited to, a rear projection screen. The display system further includes, but is not limited to, a first projector that is arranged to project a first image on the rear projection screen. The display system further includes, but is not limited to, a second projector that is arranged to project a second image on the rear projection screen. The display system still further includes a processor that is operatively coupled with the first projector and the second projector. The processor is configured to control the first projector to project the first image and to control the second projector to project the second image, and is further configured to align the second image with the first image in an overlaying manner, a portion of the second image being substantially identical to a portion of the first image.

In a second, non-limiting embodiment, the display system includes, but is not limited to a rear projection screen. The display system further includes, but is not limited to, a first projector that is arranged to project a first image on the rear projection screen. The display system further includes, but is not limited to, a second projector that is arranged to project a second image on the rear projection screen. The display system further includes, but is not limited to, a first processor that is operatively coupled with the first projector. The first processor is configured to control the first projector to project the first image. The display system still further includes, but is not limited to, a second processor that is operatively coupled with the second projector and that is communicatively coupled with the first processor. The second processor is configured to control the second projector to project the second image, to receive information from the first processor indicative of the first image, and to align the second image with the first image in an overlaying manner so as to create the appearance of a single image based, at least in part, on the information received from the first processor.

In yet another non-limiting embodiment, the method for displaying information includes, but is not limited to, projecting a first image on a rear projection screen with a first projector. The method further includes, but is not limited to projecting a second image on the rear projection screen with a second projector. The method still further includes, but is not limited to, aligning, with a processor, the first image and the second image in an overlaying manner so as to create the appearance of a single image.

### BRIEF DESCRIPTION OF THE DRAWINGS

The present invention will hereinafter be described in conjunction with the following drawing figures, wherein like numerals denote like elements, and

FIG. 1 is a block diagram illustrating a non-limiting embodiment of a display system made in accordance with the teachings of the present disclosure;

FIG. 2 is a block diagram illustrating another non-limiting embodiment of a display system made in accordance with the teachings of the present disclosure;

FIG. 3 is a block diagram illustrating another non-limiting embodiment of a display system made in accordance with the teachings of the present disclosure;

FIG. 4 is a schematic view illustrating a portion of the display system depicted in FIGS. 1-2 during simultaneous operation of two redundant projectors;

FIGS. 5-7 are schematic side views illustrating the portion depicted in FIG. 4 during consecutive operation of two redundant projectors;

FIGS. 8-9 illustrate computer alignment of the images projected by the two redundant projectors of FIGS. 4-9; and

FIG. 10 is a flow diagram illustrating a non-limiting embodiment of a method for displaying information.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale: the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments of the invention described herein are, for example, capable of use in sequences other than those illustrated or otherwise described herein.

The terms “comprise,” “include,” “have” and any variations thereof are used synonymously to denote non-exclusive inclusion. The term “exemplary” is used in the sense of “example,” rather than “ideal.”

An improved display system is disclosed herein. Although this disclosure is presented in the context of implementation onboard an aircraft, it should be understood that the technology disclosed herein is not limited for use solely with an aircraft. Rather, the technology described herein is compatible for use onboard any type of vehicle, whether now known or hereafter invented. Furthermore, the technology disclosed herein is not limited to use with a vehicle. Rather, the technology used herein is compatible for any use or application where information is displayed to a user/viewer, and in particular, in any application where the failure of a video monitor would be unacceptable.

The display system of the present disclosure provides an enhanced level of redundancy by eliminating the use of conventional display monitors. Conventional display systems utilize cathode ray tube monitors, plasma screen monitors, light emitting diode monitors, liquid crystal display monitors, and the like. The display system of the present disclosure does not utilize such conventional display monitors. Rather, in various non-limiting embodiments, the display system of the present disclosure utilizes rear projector technology. By pairing multiple projectors with a rear projection screen such that at least two projectors project a substantially identical image onto substantially the same portion of the rear projection screen, a single image can be presented to a viewer viewing the rear projection screen.

With the display system of the present disclosure, in the event that one of the projectors fails, the second projector (or any number of additional projectors) will be unaffected by such failure and will be capable of continuing to present the image despite the failure of the first projector. This arrangement provides a desirable level of redundancy. This provides a robust mission capability that facilitates the ability of a flight crew to complete its mission despite the sudden and unanticipated malfunction of a projector of the display system. This provides an advantage over existing systems wherein the failure of a single display monitor may impair the flight crew's ability to complete its mission.

A greater understanding of the display system and of the method for displaying information described above may be obtained through a review of the illustrations accompanying this application together with a review of the detailed description that follows.

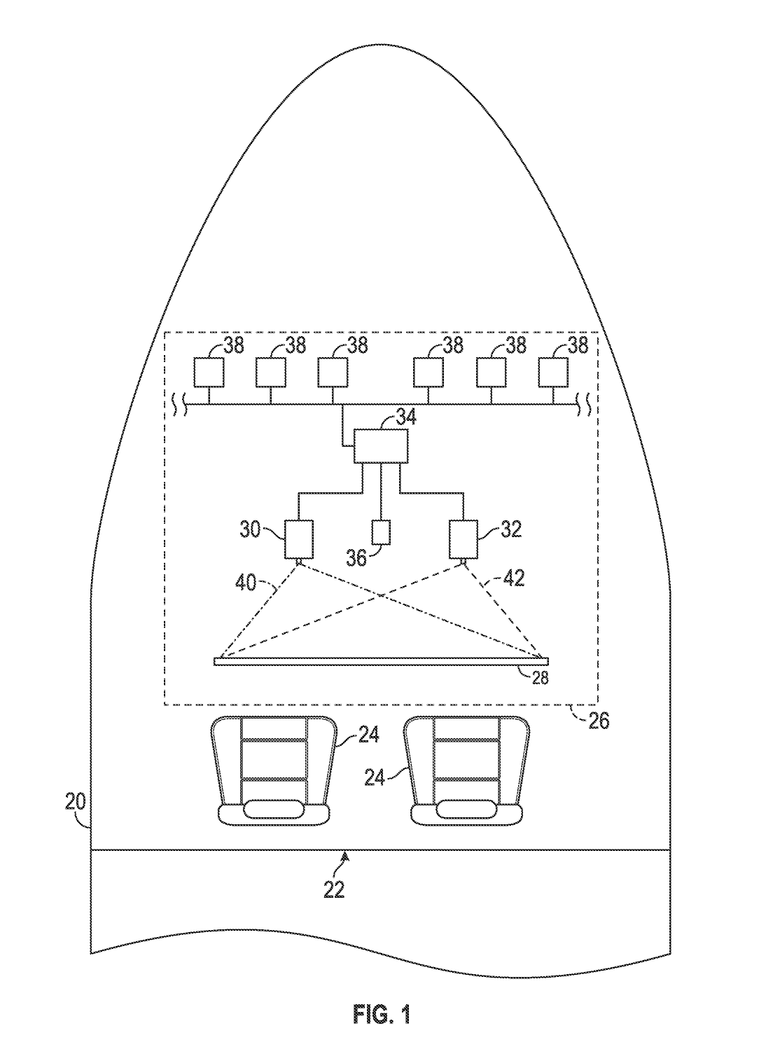

FIG. 1 is a schematic view illustrating an aircraft 20 having a flight deck 22. Flight deck 22 includes a pair of seats 24 for supporting members of a flight crew (not shown) and a non-limiting embodiment of a display system 26 for presenting information to the members of the flight crew. Flight deck 22 may further include an instrument panel (not shown) for housing and supporting a display system such as display system 26. In other embodiments, display system 26 may be utilized with any other suitable platform, including both vehicular and non-vehicular platforms and in applications that are both aviation-related and non-aviation related without departing from the teachings of the present disclosure.

In the illustrated embodiment, display system 26 includes a rear projection screen 28, a projector 30, a projector 32, a processor 34, an image sensor 36, and a plurality of condition sensors 38. In other embodiments, display system 26 may comprise either a greater or lesser number of components. For example, in some non-limiting embodiments, display system 26 may include, without limitation, one or more additional projectors or a user input device. In other embodiments, display system 26 may not include image sensor 36 or plurality of condition sensors 38.

Rear projection screen 28 may comprise any rear projection screen, now known or hereafter invented, that is configured to diffuse a projection of image-carrying light that emanates from behind the rear projection screen in order to display the image to viewers situated in front of the rear projection screen. In the illustrated embodiment, rear projection screen 28 comprises a single screen. In other embodiments, rear projection screen 28 may comprise a plurality of rear projection screens disposed in a substantially coplanar, side by side arrangement to form a composite rear projection screen. In the illustrated embodiment, rear projection screen 28 is substantially planar. In other embodiments, rear projection screen 28 may have any suitable configuration including, but not limited to a non-planar curvature, a plurality of discreet planar surfaces arranged at non-parallel angles with respect to one another, and/or combinations thereof.

Projector 30 and projector 32 may comprise any suitable conventional projector configured to project light carrying an image. In the embodiment illustrated in FIG. 1, projector 30 and projector 32 are configured to be controlled by processor 34, to receive information from processor 34, and are further configured to project light carrying an image(s) that is related to the information provided by processor 34. In the illustrated embodiments, both projector 30 and projector 32 are operatively coupled with a single processor (processor 34) and receive information therefrom for projection onto rear projection screen 28. In other embodiments (as discussed below), each projector may be associated with a separate processor.

Projector 30 is configured to project an image 40 and is arranged to project image 40 onto rear projection screen 28. Similarly, projector 32 is configured to project an image 42 and is arranged to project image 42 onto rear projection screen 28. At least a portion of image 40 and at least a portion of image 42 are identical to one another.

Projector 30 and projector 32 are positioned, focused, and/or otherwise mechanically adjusted so as to project at least a portion of their respective images onto the same region of rear projection screen 28. The goal of such positioning, focusing, and mechanical adjustment is to align the respective images of projectors 30 and 32 so identical portions of the two images overlay one another. When properly aligned, the identical portions will appear to form a single image from the standpoint of a viewer viewing rear projection screen 28. Precise alignment may not be feasible via mechanical means alone, and for this reason, processor 34 may be loaded with suitable software that enables processor 34 to precisely align the two images and to maintain such precise alignment during the flight or other mission.

Processor 34 may be any type of computer, controller, micro-controller, circuitry, chipset, computer system, or microprocessor that is configured to perform algorithms, to execute software applications, to execute sub-routines and/or to be loaded with, and to execute, any other type of computer program. Processor 34 may comprise a single processor or a plurality of processors acting in concert. In some embodiments, processor 34 may be dedicated for use exclusively with display system 26 while in other embodiments processor 34 may be shared with other systems on board aircraft 20.

Processor 34 is operatively coupled to projector 30 and to projector 32. Such coupling may be accomplished through the use of any suitable means of transmission including both wired and wireless means. For example, projector 30 and projector 32 may each be physically connected to processor 34 via a coaxial cable, an Ethernet cable, a serial cable, or via any other type of wired connection that is effective to convey signals and/or commands. In the illustrated embodiment, processor 34 is directly operatively coupled to projector 30 and to projector 32. In other embodiments, processor 34 may be operatively coupled with projector 30 and with projector 32 across a communication bus. In still other examples, each component may be wirelessly coupled to processor 34 via a short range wireless network protocol such as, but not limited to, a Bluetooth connection, a WiFi connection or the like.

Being coupled provides a pathway for the transmission of commands, instructions, interrogations and other signals between processor 34, projector 30 and projector 32. Through this coupling, processor 34 may control and/or communicate with each of the other components. For example, in some embodiments, processor 34 is configured to control projector 30 and projector 32 to display image 40 and image 42, respectively.

In some embodiments, processor 34 may be configured to cause projector 30 and projector 32 to display image 40 and image 42 concurrently. In other embodiments, processor 34 may be configured to control projector 30 and projector 32 to display image 40 and image 42 consecutively. In the case of consecutive display, processor 30 may be configured control projector 30 to project image 40 onto rear projection screen 28 while, at the same time, processor 34 instructs projector 32 to remain in an off state or a standby mode. When processor 34 detects a failure of projector 30, it may then send instructions to projector 32 that cause projector 32 to commence projection of image 42 onto rear projection screen 28. In this manner, the viewer receives a substantially uninterrupted display information on rear projection screen 28.

Regardless of whether processor 34 is configured to employ the concurrent display protocol or the consecutive display protocol, image 40 and image 42 will be relatively precisely aligned with one another to avoid confusing a viewer looking at rear projection screen 28. Such computer alignment need only be precise enough to cause a human viewer to perceive the two images (or the identical portions of the two images) as being a single image. To accomplish this, processor 34 may be loaded with any suitable alignment software that enables processor 34 to align image 40 with image 42. Such software enables display system 26 to align the two images with greater precision than is feasible using mechanical means alone. Examples of suitable alignment software include Immersaview produced and offered for sale by Immersive Display Solutions Inc. of Kennesaw, Ga.

In some embodiments, image 40 and image 42 may be substantially identical with one another in their entirety. In such cases, the entirety of image 42 would be overlaid onto, and aligned with, the entirety of image 40. In other cases, only a portion of image 42 may be identical to a portion image 40. In such other cases, only the identical portions of each image would be overlaid onto, and aligned with, one another. The extent to which the images are identical would be known in advance and when performing the mechanical alignment, the projector 30 and projector 32 would be mechanically aligned such that only the identical portions of image 40 and image 42 are overlaid onto one another in the same region of rear projection screen 28.

In both scenarios, processor 34 will execute the alignment software to precisely align the two images (or the identical portions thereof) with one another. The identical portions will be overlaid onto one another such that identical portions of each image are projected onto the same location on rear projection screen 28. To accomplish this, processor 34 may need to stretch, shrink, shift, displace, or in any other manner, relocate the image projected by one or both of the projectors to align with the image projected by the other. Thus, regardless of whether processor 34 is configured to present the two images simultaneously or consecutively, both images will appear at precisely the same location on rear projection screen 28.

In some embodiments, processor 34 may be further configured to detect when projector 30 or projector 32 fails. Such detection may be accomplished based on the information processor 34 receives from projector 30 or projector 32 via their communicative coupling. Being configured in this manner allows processor 34 to provide notification to a user/operator that appropriate maintenance or repairs are needed and further allows processor 34 to give appropriate commands to switch from the malfunctioning projector to the operational projector upon the detection of the malfunction.

In other embodiments, however, it may be desirable for display system 26 to include image sensor 36 to detect the failure of one of the projectors. Image sensor 36 may comprise any type or variety of sensor that is capable of detecting the failure of projector 30 or projector 32 to project image 40 or image 42, respectively, onto rear projection screen 28. For example, and without limitation, image sensor 36 may comprise a photo cell capable of detecting the presence or absence of light. Alternatively, image sensor 36 may comprise a video camera. In still other embodiments, image sensor 36 may be communicatively coupled with projector 30 and/or with projector 32 and may be configured to electronically monitor for the present or absence of an output from each projector. Any other device capable of detecting when image 40 or image 42 may also be employed with display system 26.

Image sensor 36 is communicatively coupled with processor 34 and is configured to provide information indicative of the operability of projector 30 and/or projector 32 to processor 34. Image sensor 36 and processor 34 may be communicatively coupled with one another in any suitable manner, including via both wired and wireless means. Processor 34 is configured to receive such information from image sensor 36 and to utilize such information. In some embodiments, processor 34 may be configured to utilize such information to provide a warning or to send an alert to a user indicative of the failure/malfunction of projector 30 or projector 32. In other embodiments, such as those where processor 34 is configured to present image 40 and image 42 consecutively, processor 34 may be configured to control projector 32 to project image 42 onto rear projection screen 28 after receiving information indicative of the failure or malfunction of projector 30.

Display system 26 further includes a plurality of condition sensors 38. In the illustrated embodiment, condition sensors 38 are sensors that are configured to detect the condition of aircraft 20. Examples of devices that may serve as condition sensors 38 include, but are not limited to, pitot static tubes, accelerometers, Global Positioning Satellite (GPS) receivers, thermal sensors, engine monitors, altimeters, and the like. In other embodiments, such as those where display system 26 is employed on vehicles other than aircraft or in a setting other than on a vehicle, condition sensors 38 may be configured to detect the presence or absence of any condition relevant to the system that employs display system 26.

Condition sensors 38 are communicatively coupled with processor 34 and are configured to provide information indicative of their respective sensed conditions to processor 34. Condition sensors 38 and processor 34 may be communicatively coupled with one another in any suitable manner, including via both wired and wireless means. Processor 34 is configured to receive such information from condition sensors 38 and to utilize such information. For example, in some embodiments, processor 34 may be configured to utilize such information to control projector 30 and/or projector 32 to include graphics or text in image 40 and image 42, respectively that is indicative of the information provided by condition sensors 38.

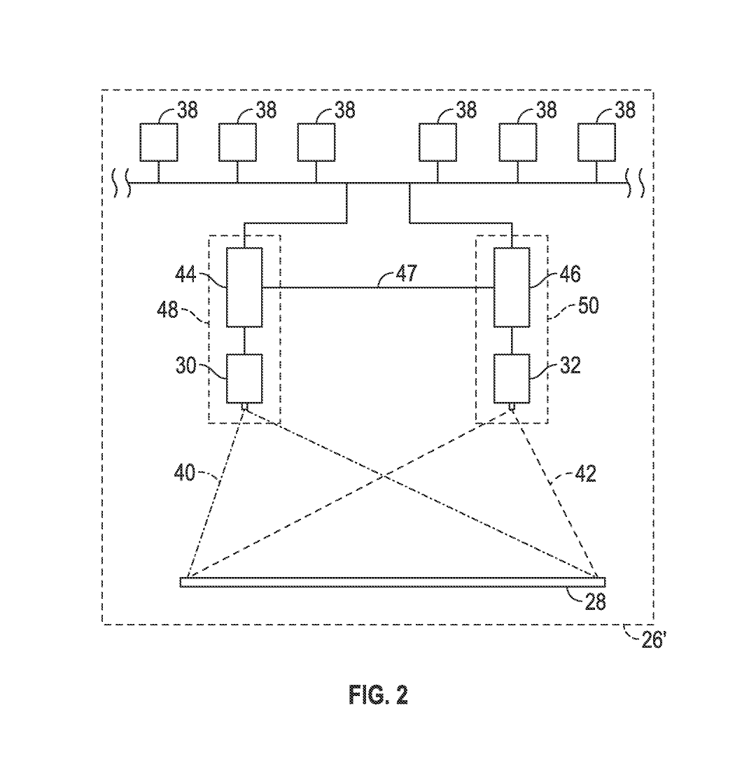

With continuing reference to FIG. 1, FIG. 2 presents a schematic view illustrating a display system 26′, which is an alternate embodiment of display system 26. As illustrated in FIG. 2, display system 26′ includes many of the same components as display system 26. For example, display system 26′ and display system 26 each include rear projection screen 28, projector 30 configured to project image 40, projector 32 configured to project image 42, and a plurality of condition sensors 38. Because these components are identical in each display system, the description provided above for these components applies here with equal force and for the purposes of brevity, will not be repeated.

The primary difference between display system 26 and display system 26′ is that display system 26 utilizes a single processor (processor 34) while display system 26′ utilizes two processors. Processor 44 is operatively coupled with projector 30 and is configured to control projector 30 to project image 40 onto rear projection screen 28 and may also be configured to detect a malfunction of projector 30. Similarly, processor 46 is operatively coupled with projector 32 and is configured to control projector 32 to project image 42 onto rear projection screen 28 and may also be configured to detect a malfunction of projector 32. Processor 44 and processor 46 are each communicatively coupled with the plurality of condition sensors 38, and are configured to receive information from the plurality of condition sensors 38 and to use such information to control their respective projectors to project their respective images.

As illustrated in FIG. 2, processor 44 and processor 46 are communicatively coupled with one another. Processor 44 and processor 46 may be communicatively coupled with one another in any suitable manner including, but not limited to, both wired and wireless configurations. In the illustrated embodiment, processor 44 and processor 46 are communicatively coupled to one another via an Ethernet cable 47. Processor 46 is configured to ascertain information about image 40 by communicating with processor 44 across Ethernet cable 47. Processor 46 is loaded with software that enables processor 46 to control the projection of image 42 and to align image 42 with image 40 in the same manner described above with respect to processor 34. In some embodiments, processor 44 may also be configured to ascertain information about image 42 by communicating with processor 46 across Ethernet cable 47. Furthermore, processor 44 may also be loaded with software that enables processor 44 to control the projection of image 40 and to align image 40 with image 42 in the same manner described above with respect to processor 34. In this manner, each processor may be configured to control the projection of its respective image to align that image with the image projected by the other projector. In other embodiments, processor 44 and processor 46 may each be configured to cooperate with one another to modify or relocate both image 40 and image 42 to form a precisely aligned composite image.

In the illustrated embodiment, processor 44 and processor 46 are configured to cooperate to control their respective projectors in accordance with either a concurrent display protocol or a consecutive display protocol, as discussed above. In other embodiments, only one of the processors need be configured to follow the concurrent display protocol or the consecutive display protocol. In such embodiments, a first processor (either processor 44 or processor 46) would be configured to control its respective projector to continuously project its respective image while a second processor (the other of processor 44 or processor 46) would be configured to either concurrently or consecutively control its respective projector to project its respective image. When the projector associated with the first processor experiences a malfunction, the second processor would learn of such malfunction by communicating with the first processor via Ethernet cable 47 and could respond accordingly. Such communicative coupling between processor 44 and processor 46 may entirely eliminate the need for image sensor 36. In other embodiments, it may be desirable to include image sensor 36 despite such communicative coupling between processor 44 and processor 46 in order to provide greater levels of redundancy.

In some embodiments, projector 30 and processor 44 may be integrated into a single component, such as projector assembly 48. Similarly, projector 32 and processor 46 may be integrated into a single component, such as projector assembly 50. Such a configuration may permit display system 26′ to have a more compact arrangement that facilitates packaging in an instrument panel or in a housing.

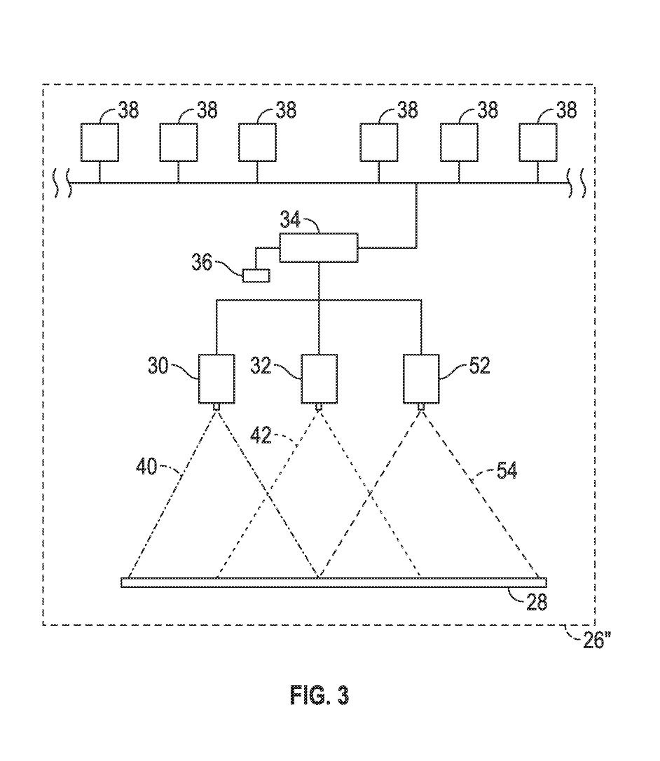

With continuing reference to FIGS. 1-2, FIG. 3 presents a schematic view illustrating a display system 26″, which is another alternate embodiment of display system 26. As illustrated in FIG. 3, display system 26″ includes all of the same components as display system 26 plus an additional component. With respect to the same components (i.e., rear projection screen 28, projector 30 configured to project image 40, projector 32 configured to project image 42, image sensor 36, and plurality of condition sensors 38), because these components are identical to the components discussed above with respect to FIG. 1, the description provided above for these components applies here as well.

The primary difference between display system 26 and display system 26″ is that display system 26″ employs an additional projector 52 communicatively coupled with processor 34. The arrangement illustrated in FIG. 3 may be employed in instances where multiple projectors are needed to fill the entire area of rear projection screen 28 because of its size or for any other reason. As illustrated, projector 52 projects an image 54 onto half of rear projection screen 28 while projector 30 projects image 40 onto the other half of rear projection screen 28.

As illustrated, image 54 and image 40 are aligned in a side by side manner. Projector 32 is situated between projector 30 and projector 52 and projects image 42 so that a portion of image 42 overlays image 40 and a portion of image 42 overlays image 54. The portion of image 42 overlaying image 40 and the portion of image 40 that is overlaid are substantially identical. Similarly, the portion of image 42 overlaying image 54 and the portion of image 54 overlaid are also substantially identical. Processor 34 is configured to precisely align the substantially identical portions of image 42 with image 40. In this embodiment, processor 34 is further configured to also precisely align the substantially identical portions of image 42 with image 40.

The arrangement illustrated in FIG. 3 may be employed in circumstances where complete redundancy of all of the displayed information may not be necessary. For example, it may be desirable to provide redundancy for some of the more mission-critical information projected by projector 30 and projector 52, while leaving the less mission-critical information without a means of redundant display. This permits the use of fewer redundant projectors such as projector 32, allowing display system 26″ to have a lower weight, a lower cost, and a lower complexity.

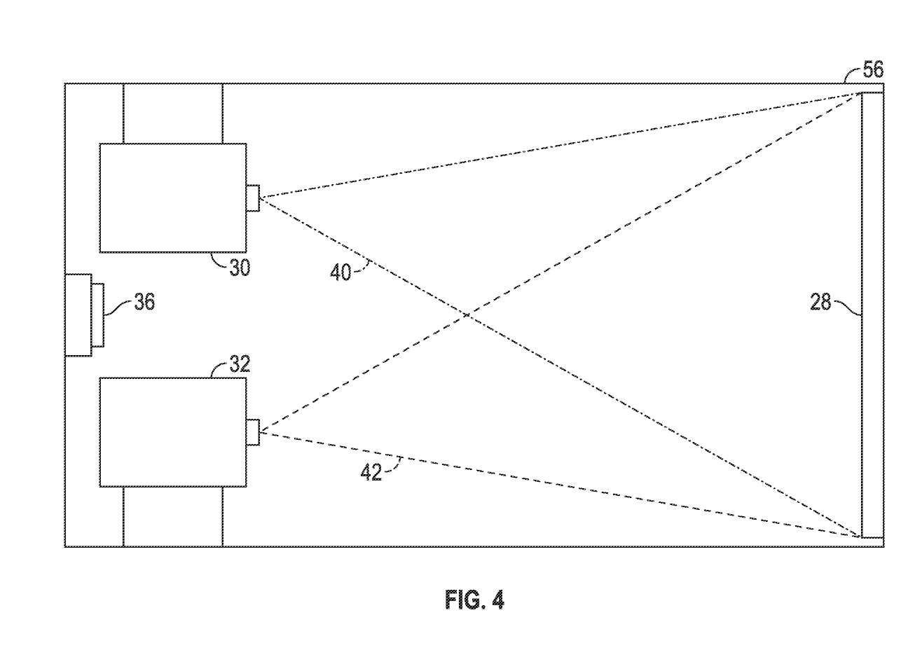

FIG. 4 is a schematic view illustrating a housing 56 in which rear projection screen 28, projector 30, projector 32, and image sensor 36 are mounted. These components may be mounted to housing 56 in any desired manner including, but not limited to, the use of adhesives and mechanical fasteners of any type or variety. With continuing reference to FIGS. 1-3, housing 56 is compatible for use with display system 26, display system 26′, and display system 26″, and/or with any other display system made in accordance with the teachings of the present disclosure. In some embodiments, housing 56 may be configured for mounting within an instrument panel.

An advantage associated mounting projector 30 and projector 32 and rear projection screen 28 (and all other components of display system 26) in a single housing is to reduce the effect of vibrations experienced by display system 26 on the image presented to an aircrew. If the individual components were mounted to separate or disconnected structures, then the vibrations experienced by each component would correspond to the structure to which it is mounted. With all components of display system mounted to a single structure (e.g., housing 56), then each component will experience substantially the same vibration at substantially the same time, thus diminishing the likelihood of different vibration frequencies impacting the presentation of the image to the aircrew.

Projector 30 and projector 32 are mounted within housing 56 and are adjusted and/or aligned to project images 40 and 42, respectively, in an at least a partially overlapping manner onto rear projection screen 28. As discussed above, the two images may be substantially identical in their entirety, in which case they will substantially completely overlap one another. In other examples, only portions of the images may be identical, in which case, projector 30 and projector 32 will be mounted such that only the identical portions of image 40 and image 42 overlap one another.

In the illustrated embodiment, projector 30 and projector 32 are mounted in an inverted relationship with projector 30 mounted to an upper surface of 56 and with projector 32 mounted to a lower surface of housing 56. When mounted in this manner, projector 30 may be mounted upside down. In that case, the processor associated with projector 30 would be configured to invert the image projected from projector 30 so that it will be projected with the same orientation as the image projected from projector 32. In other embodiments, projector 30 and projector 32 may be mounted in a side-by-side relationship to the same surface of housing 56. In other embodiments, projector 30 and projector 32 may be mounted to surfaces that are disposed orthogonally to one another. In still other embodiments, additional projectors may be mounted to housing 56 and may be oriented to project their respective images in an overlapping manner with the images projected by projector 30 and projector 32.

In the embodiment illustrated in FIG. 4, both projector 30 and projector 32 are concurrently projecting image 40 and image 42 onto rear projection screen 28. The images are aligned by a processor such as processor 34 or processor 44 or processor 46. Accordingly, an aircrew member viewing rear projection screen 28 from the vantage point of seat 24 (or elsewhere in flight deck 22) will perceive only a single image. Failure of either projector 30 or projector 32 will not result in an inability to display an image to an aircrew member. When employing a concurrent projection protocol, image sensor 36 may not be utilized and, in some embodiments, may be excluded.

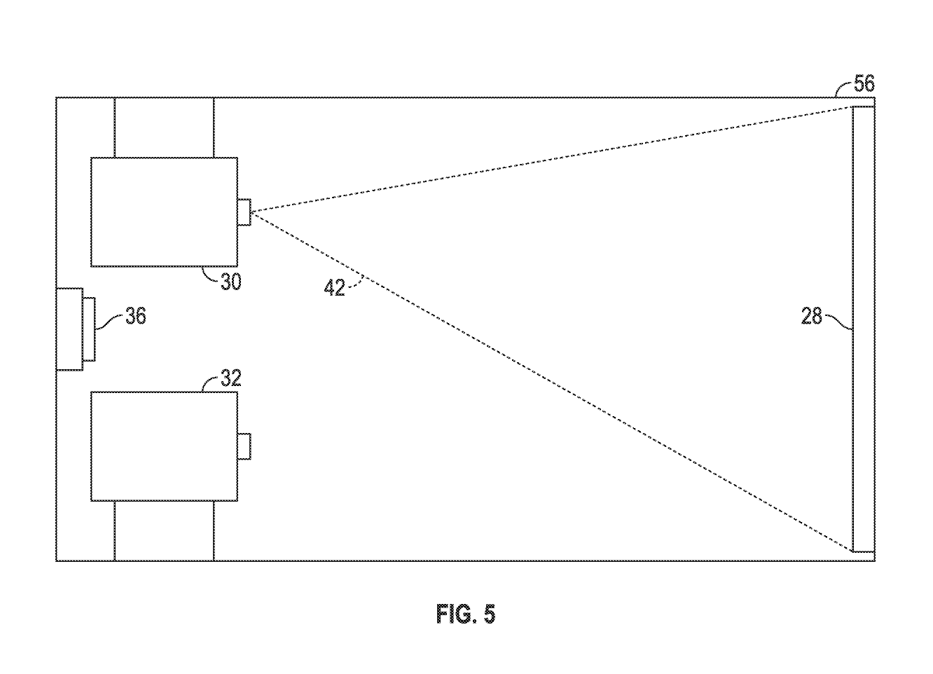

FIGS. 5-7 illustrate the arrangement of FIG. 4 during operations when the display system is employing a consecutive projection protocol. With continuing reference to FIGS. 1-4, in FIG. 5, projector 30 projects image 40 onto rear projection screen 28 while projector 32 remains in a standby mode and does not project image 42. Image sensor 36 is configured to detect the presence or absence of an image (either image 40 or image 42) and is further configured to send an alert to processor 34 (or processor 44 or processor 46) when the image projected onto rear projection screen 28 is discontinued.

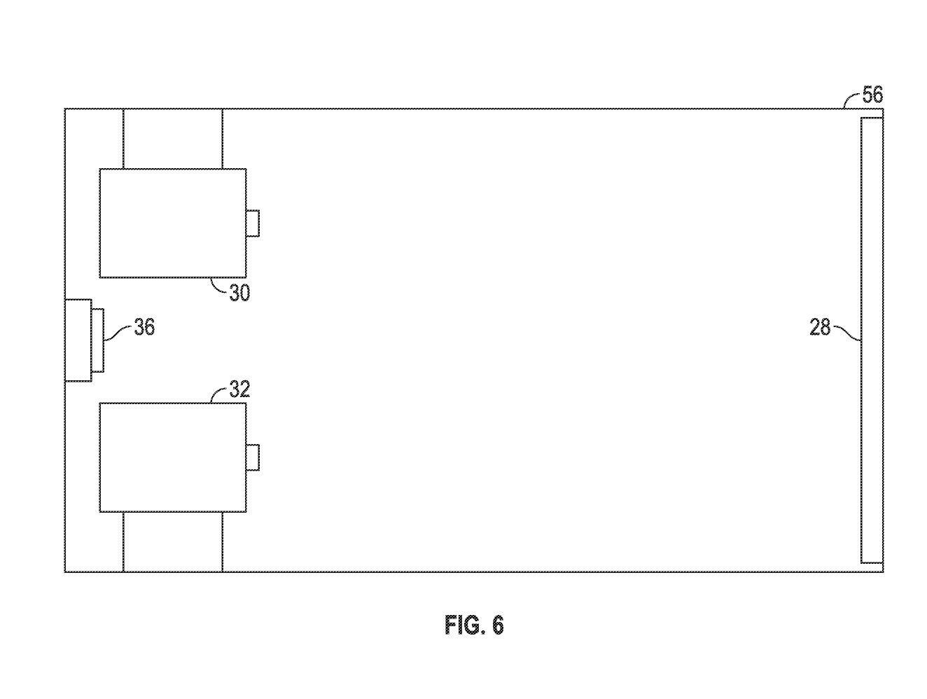

FIG. 6 illustrates a condition wherein projector 30 has malfunctioned and has discontinued its projection of image 40 onto rear projection screen 28. Under these conditions, image sensor 36 will detect the absence of an image on rear projection screen 28 and will send an alert to the processor controlling the display system. In systems employing multiple communicatively coupled processors, the processor associated with the failed projector will detect the failure and will send an alert to the other projector. In response to receiving the alert, the processor will send an instruction/command to projector 32 to commence projection of image 42.

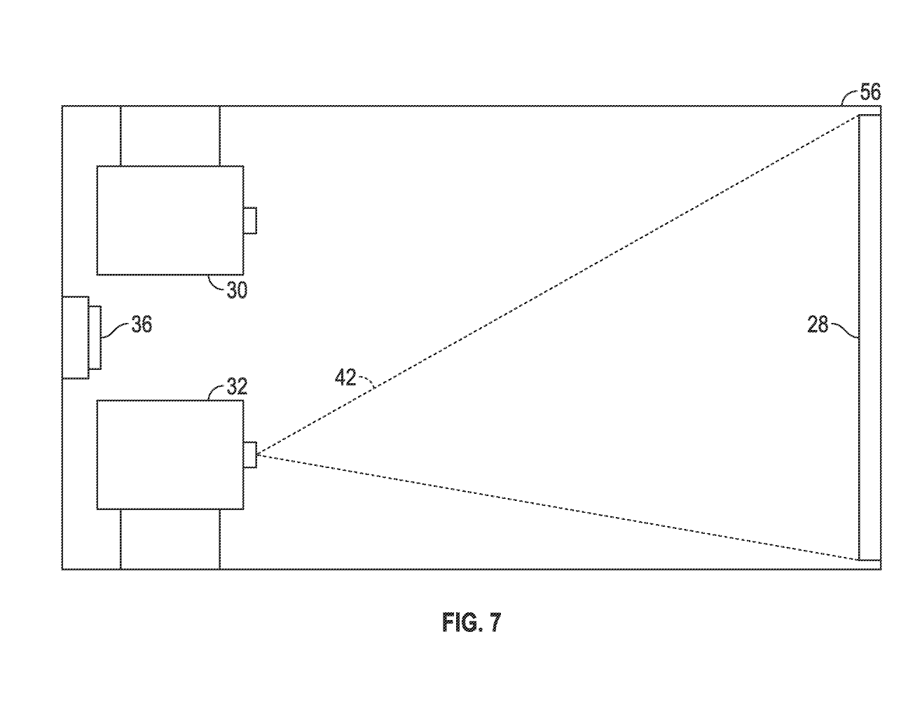

FIG. 7 illustrates projector 32 after it has commenced projection of image 42 onto rear projection screen 28. In the illustrated embodiment, image 42 is substantially identical to image 40. Image sensor 36 and the processor of the display system (e.g., processor 34, processor 44, and/or processor 46) may be configured to detect the absence of an image and to instruct the second projector to commence projection of the second image within a relatively short period of time. Accordingly, from the perspective of a member of the aircrew, there will be substantially no interruption of display and the switch from projector 30 to projector 32 may appear to be a flicker or may be entirely undetectable.

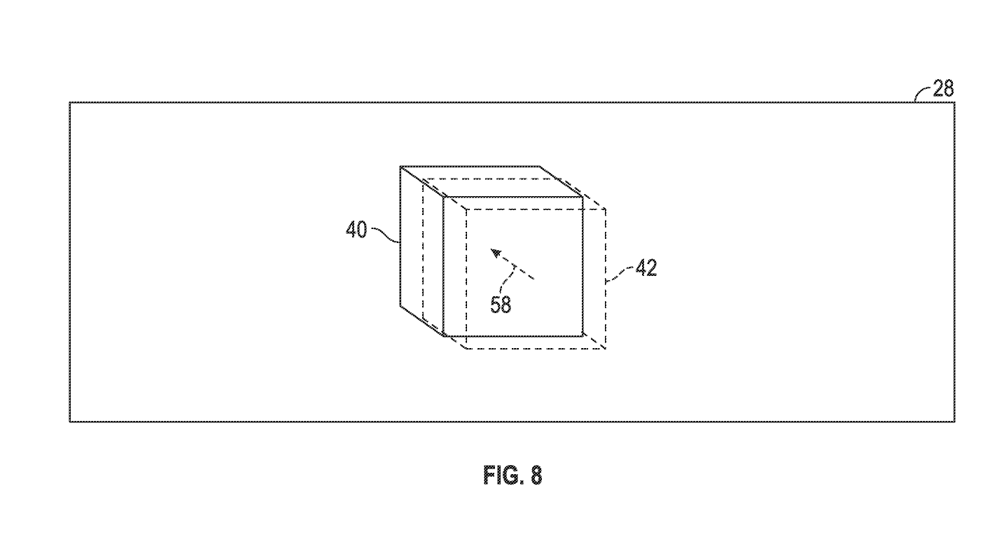

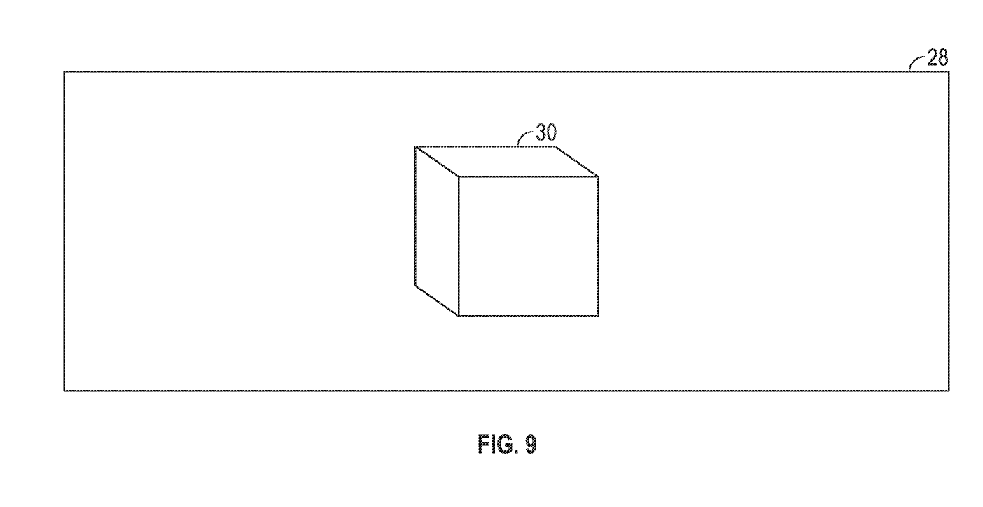

FIGS. 8 and 9 illustrate the focusing and alignment performed by a processor of the display system of the present disclosure. FIG. 8 presents a view of rear projection screen 28 from the vantage point of a member of the air crew. In this example, both image 40 and image 42 are presented on rear projection screen 28 concurrently. With continuing reference to FIGS. 1-7, despite the mechanical alignment of projector 30 and projector 32 with one another, image 40 and image 42 are, nevertheless, slightly out of alignment. An arrow 58 illustrates the direction in which image 42 needs to be adjusted in order to come into alignment with image 40. Such alignment is performed by processor 34 (or by processor 44 or by processor 46 depending on which display system is in use). The processor controls projector 32 to manipulate image 42 as needed to properly align the two images. In some examples, the projector may need to stretch, shrink, elongate, shift, or otherwise adjust the projection of one of the images in order to bring it into alignment with the other image(s).

FIG. 9 illustrates rear projection screen 28 after the processor has completed focusing images 40 and image 42. A composite image 43 is presented to the aircrew that appears to be a single image.

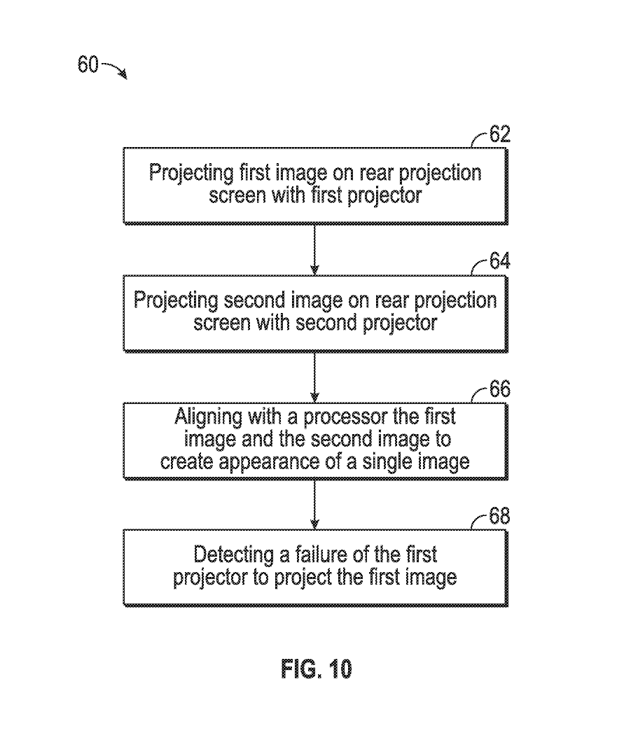

FIG. 10 illustrates a non-limiting embodiment of a method 60 for displaying information. With continuing reference to FIGS. 1-9, method 60 may be performed using any suitable display system including, but not limited to, display system 26. Method 60 may be performed in any environment including, but not limited to, onboard an aircraft.

At step 62, a first image is projected onto a rear projection screen using a first projector. Any suitable projector may be utilized and the projector and the rear projection screen may be employed in any desirable environment. In an exemplary environment, the first projector and the rear projection screen are mounted within the instrument panel in the flight deck of an aircraft.

At step 64, a second image is projected onto the rear projection screen by a second projector. The second image includes a portion that is substantially identical to a portion of the first image. In some examples the entire second image may be identical to the entire first image. In some examples, the second image is displayed concurrently with the first image while in other examples, the second image is displayed consecutively with the first image (e.g., after the first image is no longer displayed).

At step 66, a processor is used to align the two images. The processor may align the two images so that the portions of each image that are identical are displayed at the same location on the rear projection screen. This has the effect of creating the appearance of only a single image. The processor may shift, displace, stretch, shrink, or otherwise reposition or alter the images in any manner necessary to facilitate a precise overlay so that only a single image is perceived (in the case of concurrent display) or so that the image does not appear to shift positions (in the case of consecutive display).

At step 68, a failure of one of the projectors to project an image is detected. This may be accomplished using any suitable detector or by the processor associated with the projector. Such detection may serve as a trigger that initiates the projection of the second image in an embodiment where the two images are displayed consecutively. In embodiments that employ a concurrent display protocol, such detection may be communicated to a member of the aircrew or any other person viewing the rear projection screen to alert them to the need for maintenance or repair.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A display system comprising:
a rear projection screen;
a first projector arranged to project a first image on the rear projection screen;
a second projector arranged to project a second image on the rear projection screen; and
a processor operatively coupled with the first projector and the second projector, the processor configured to control the first projector to project the first image and to control the second projector to project the second image, and further configured to align the second image with the first image in an overlaying manner so as to create the appearance of a single image, a portion of the second image being substantially identical to a portion of the first image.

2. The display system of claim 1, wherein the processor is configured to control the second projector to project the second image such that the second image is coextensive with the first image.

3. The display system of claim 1, wherein the processor is configured to control the first projector and the second projector to display the first image and the second image concurrently.

4. The display system of claim 1, wherein the processor is configured to control the second projector to display the second image in response to a failure of the first projector to display the first image.

5. The display system of claim 4, further comprising:
an image sensor configured to detect when the first projector fails to project the first image,
wherein the processor is communicatively coupled with the image sensor and is further configured to receive information from the image sensor indicative of the failure of the first projector to project the first image and to control the second projector to commence projection of the second image in response to receiving such information from the image sensor.

6. The display system of claim 1, further comprising:
a condition sensor configured to detect a condition of a vehicle associated with the condition sensor,
wherein the processor is communicatively coupled with the condition sensor and is further configured to:
receive information from the condition sensor indicative of the condition of the vehicle,
control the first projector to project an updated first image reflective of the condition of the vehicle based, at least in part, on the information received from the condition sensor, and
control the second projector to project an updated second image reflective of the condition of the vehicle based, at least in part, on the information received from the condition sensor.

7. The display system of claim 1, further comprising:
a housing,
wherein the rear projection screen, the first projector, and the second projector are mounted within the housing.

8. The display system of claim 7, wherein the first projector and the second projector are mounted in a manner such that the first projector and the second projector are inverted with respect to one another and wherein the processor is configured to control the second projector to invert the second image.

9. The display system of claim 1, wherein the processor is configured to use image correction software to align the second image with the first image.

10. The display system of claim 1, further comprising:
a third projector arranged to project a third image on the rear projection screen at a location substantially adjacent to the first image,
wherein the processor is operatively coupled with the third projector and is further configured to control the third projector to project the third image and is still further configured to align the second image with both the first image and the third image in an overlaying manner so as to create the appearance of the single image.

11. A display system comprising:
a rear projection screen;
a first projector arranged to project a first image on the rear projection screen;
a second projector arranged to project a second image on the rear projection screen;
a first processor operatively coupled with the first projector, the first processor configured to control the first projector to project the first image; and
a second processor operatively coupled with the second projector and communicatively coupled with the first processor, the second processor configured to control the second projector to project the second image, to receive information from the first processor indicative of the first image, and to align the second image with the first image in an overlaying manner so as to create the appearance of a single image based, at least in part, on the information received from the first processor, a portion of the second image being substantially identical to a portion of the first image.

12. The display system of claim 11, wherein the second processor is configured to control the second projector to project the second image such that the second image is coextensive with the first image.

13. The display system of claim 12, wherein the first processor and the first projector are integrated into a first component and wherein the second processor and the second projector are integrated into a second component.

14. The display system of claim 11, wherein the second processor is configured to control the second projector to display the second image concurrently with the first processor controlling the first projector to display the first image.

15. The display system of claim 11, wherein the second processor is configured to control the second projector to display the second image in response to a failure of the first projector to display the first image.

16. The display system of claim 15, wherein the second processor is configured to determine when the first processor fails to project the first image based on the information from the first processor and is still further configured to control the second projector to commence projection of the second image in response to making such determination.

17. The display system of claim 11, further comprising:
a condition sensor configured to detect a condition of a vehicle associated with the condition sensor,
wherein the first processor is communicatively coupled with the condition sensor and is further configured to:
receive information from the condition sensor indicative of the condition of the vehicle,
control the first projector to project an updated first image reflective of the condition of the vehicle based, at least in part, on the information received from the condition sensor, and
wherein, the second processor is communicatively coupled with the condition sensor and is further configured to:
receive information from the condition sensor indicative of the condition of the vehicle,
control the second projector to project an updated second image reflective of the condition of the vehicle based, at least in part, on the information received from the condition sensor.

18. A method for displaying information, the method comprising the steps of:
projecting a first image on a rear projection screen with a first projector;
projecting a second image on the rear projection screen with a second projector, a portion of the second image being substantially identical to a portion of the first image; and
aligning, with a processor, the first image and the second image in an overlaying manner so as to create the appearance of a single image.

19. The method of claim 18, wherein the step of projecting the second image is performed concurrently with the step of projecting the first image.

20. The method of claim 18, further comprising the step of:
detecting a failure of the first projector to project the first image,
wherein the step of projecting the second image is performed after the failure has been detected.
